(19) United States
(12) Patent Application Publication
(10) Pub. No.: US 2012/0262068 A1
(43) Pub. Date: Oct. 18, 2012

(54) LED DRIVING CIRCUIT

(75) Inventors: DER-HO CHI, Tu-Cheng (TW); YANG-JUI CHAO, Tu-Cheng (TW); ZHI-QIANG XIE, Shenzhen City (CN); JI-BAO FU, Shenzhen City (CN); WEN-TAO WU, Shenzhen City (CN); MI TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/245,873

(22) Filed: Sep. 27, 2011

(30) Foreign Application Priority Data
Apr. 18, 2011 (CN) 201110095691.4

(51) Int. Cl. H05B 37/02

(52) U.S. Cl. 315/122; 315/186

(57) ABSTRACT

An LED (light emitting diode) driving circuit includes a rectifying circuit, an LED module, a voltage dropping circuit connected to the LED module, a voltage detecting circuit connected between the voltage dropping circuit and the LED module, and an integrated circuit. The integrated circuit includes a pulse-width modulation (PWM) control module providing PWM waves, an overcurrent protection (OCP) module, an overvoltage protection (OVP) module, and a frequency control module. The OCP module detects the working current of the LED module, and the OVP module detects the working voltage. The frequency control module adjust the duty cycle of the PWM waves according to the results of comparisons made by the OCP module and the OVP module against reference levels, to adjust the working current of the LED module.

### BACKGROUND

1. Technical Field

The present disclosure relates to an LED (light-emitting diode) driving circuit.

2. Description of the Related Art

LED driving circuits are for providing and controlling electric power to LED modules. Many LED driving circuits with transformers for converting voltage are complicated. Furthermore, LEDs in an LED module powered by the LED driving circuit are connected in parallel, which causes the current of each LED branch to be different. Thus, the service life of the LEDs is shortened.

Therefore, there is room for improvement within the art.

### BRIEF DESCRIPTION OF THE DRAWINGS

The components in the drawings are not necessarily drawn to scale, the emphasis instead being placed upon clearly illustrating the principles of an LED driving circuit. Moreover, in the drawings, like reference numerals designate corresponding parts throughout the several views.

FIG. 1 is a block diagram of an LED driving circuit in accordance with an exemplary embodiment.

FIG. 2 is a circuit diagram of the LED driving circuit of FIG. 1.

### DETAILED DESCRIPTION

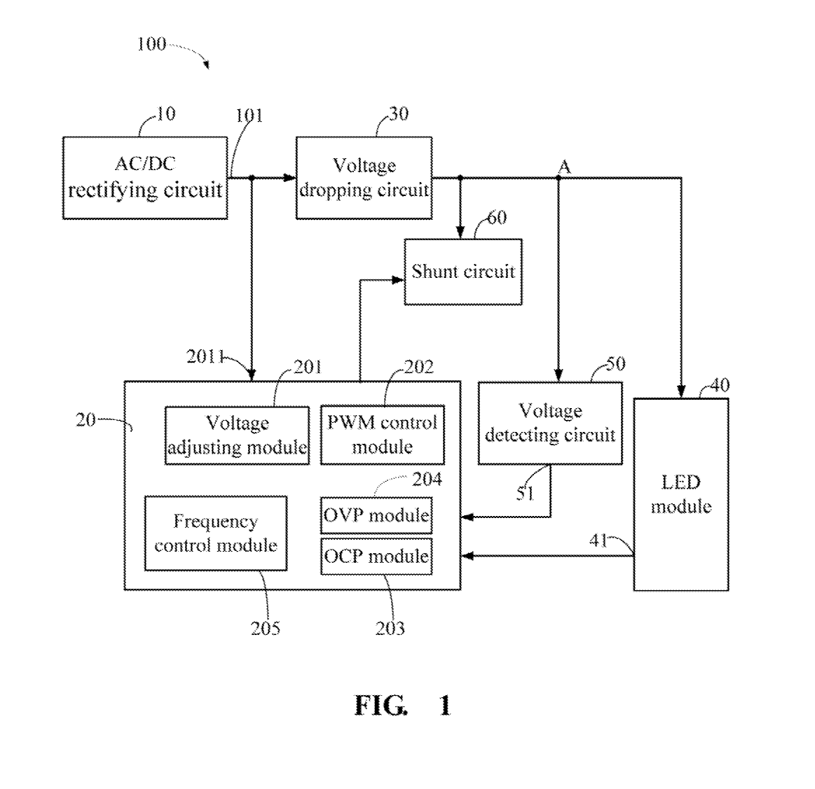

Referring to FIG. 1, an LED driving circuit 100 includes an alternating current and direct current (AC/DC) rectifying circuit 10, an integrated circuit 20, a voltage dropping circuit 30, an LED module 40, a voltage detecting circuit 50, and a shunt circuit 60. The circuit 10 is configured for converting alternating current into direct current. The direct current flows to the integrated circuit 20 and the voltage dropping circuit 30. The voltage dropping circuit 30 is connected to the LED module 40 and provides power for the LED module 40. The LED module 40 includes a current detecting terminal 41 connected to the integrated circuit 20. The voltage detecting circuit 50 is connected to an intersection A between the voltage dropping circuit 30 and the LED module 40, and is configured for detecting working voltage of the LED module 40. In the embodiment, the voltage detecting circuit 50 includes a voltage detecting terminal 51 connected to the integrated circuit 20.

The integrated circuit 20 is configured for maintaining the LED module 40 in a normal mode by controlling the working current of the LED module 40. In the embodiment, the integrated circuit 20 includes a voltage adjusting module 201, a Pulse-Width Modulation (PWM) control module 201, an overcurrent protection (OCP) module 203, an overvoltage protection (OVP) module 204, and a frequency control module 205. The voltage adjusting module 201 includes a voltage input 2011 connected to the voltage output 101 of the circuit 10. The voltage adjusting module 201 is configured for converting the high voltage output of the circuit 10 into a low voltage suitable for powering the integrated circuit 20.

The OCP module 203 and the OVP module 204 are configured for monitoring the LED module 40. In the embodiment, the OCP module 203 detects the working current of the LED module 40 via the current detecting terminal 41. The OVP module 204 detects the working voltage of the LED module 40 via the voltage detecting terminal 51.

The frequency control module 205 is configured to adjust the duty ratio of the PWM waves output from the PWM control module 202 according to the working current detected by the OCP module 203 and the working voltage detected by the OVP module 204, so as to maintain an appropriate level of power to the LED module 40.

In the embodiment, the PWM control module 202 is connected to the shunt circuit 60. The current provided by the voltage dropping circuit 30 flows periodically to the shunt circuit 60 according to the PWM wave provided by the PWM control module 202. Thereby, the current provided by the voltage dropping circuit 30 and flowing to the LED module 40 can be retained within a predetermined range. The working current in such a predetermined range causes the

LED module 40 to be in the normal mode.

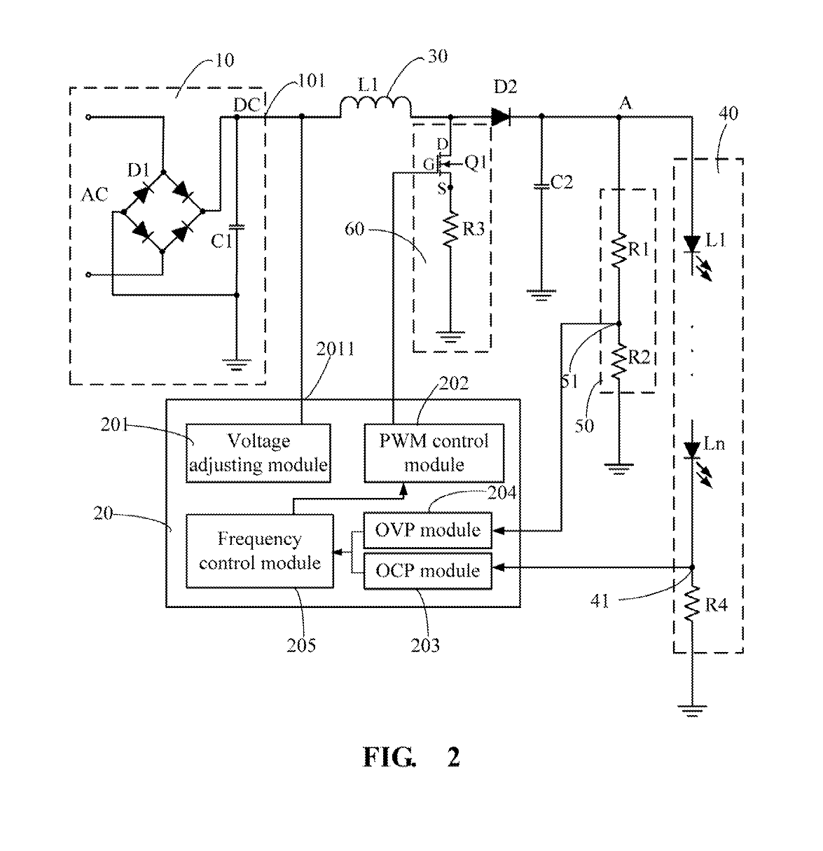

Referring to FIG. 2, the circuit 10 includes a bridge rectifier D1. The bridge rectifier D1 converts alternating current into direct current which flows to the voltage adjusting module 201 and the voltage dropping circuit 30.

The voltage dropping circuit 30 includes an inductance L1 connected between the voltage output 101 of the circuit 10 and the LED module 40 via a diode D2. The high voltage converted by the circuit 10 is converted into a low voltage by the voltage dropping circuit 30 due to the inductance of L1.

The LED module 40 includes a number of LEDs, L1-Ln, connected in series. All the LEDs are grounded via a resistor R4. The current detecting terminal 41 is arranged between the resistor R4 and the adjacent LED Ln.

The voltage detecting circuit 50 includes a first dividing resistor R1 and a second dividing resistor R2 connected in series. The voltage detecting terminal 51 is arranged between one terminal of the first dividing resistor R1 and one terminal of the second dividing resistor R2. The other terminal of the first dividing resistor R1 is connected to the intersection A. The other terminal of the second divider resistor R2 is grounded.

The shunt circuit 60 includes a switch Q1 and a resistor R3. In the embodiment, the switch Q1 is an N-channel metal oxide semiconductor (NMOS). The gate of the NMOS is connected to the PWM control module 202, the source of the NMOS is grounded via the resistor R3, and the drain of the NMOS is connected to the inductance L1 and grounded via the diode D2 and a capacitor C2.

When the PWM control module 202 outputs a low level or negative voltage, such as −5V, the switch Q1 is turned off, the shunt circuit 60 is disconnected from the voltage dropping circuit 30, and, maintained by the inductor L1, the current may flow to the LED module 40 directly. Otherwise, when the PWM control module 202 outputs a high level or positive voltage, such +5V, the switch Q1 is turned on, the shunt circuit 60 is connected to the voltage dropping circuit 30, and again, subject to the inductor L1, the current may flow to the shunt circuit 60 directly. Thus, the shunt circuit 60 is connected to and disconnected from the voltage dropping circuit 30 periodically by the PWM wave provided by the PWM control module 202, thereby controlling the current (provided by the voltage dropping circuit 30) which is allowed to flow to the LED module 40. Thus current may flow either to the LED module 40 or to the shunt circuit 60, enabling the adjustment of the working current for the LED module 40.

In the embodiment, when the LED module 40 is being supplied with power, the OCP module 203 compares the current value at the current detecting terminal 41 against a reference current, and the OVP module 204 compares the voltage value at the voltage detecting terminal 51 against a reference voltage. The frequency control module 205 controls the duty ratio of the PWM waves provided by the PWM control module 202 according to the results of the comparisons made by the OCP module 203 and by the OVP module 204.

In the embodiment, when the OCP module 203 determines that the working current of the LED module 40 is higher than the reference current, or the OVP module 204 determines that the working voltage of the LED module 40 is higher than the reference voltage, the frequency control module 205 increases the duty ratio of the PWM wave provided by the PWM control module 202, thereby increasing the connection time of the shunt circuit 60 and the voltage dropping circuit 30. Thus, the amount of time for which the current (provided by voltage dropping circuit 30) is allowed to flow to the LED module 40 is decreased, to restore the LED module 40 to a normal mode. Otherwise, when the OCP module 203 determines the working current of the LED module 40 is lower than the reference current, or the OVP module 204 determines the working voltage of the LED module 40 is lower than the reference voltage, the frequency control module 205 decreases the duty ratio of the PWM wave, thereby decreasing the connection time of the shunt circuit 60 and the voltage dropping circuit 30. Thus, the amount of time for which the current is allowed to flow to the LED module 40 is increased, to once again restore the LED module 40 to a normal mode.

It is understood that the present disclosure may be embodied in other forms without departing from the spirit thereof. The present examples and embodiments are to be considered in all respects as illustrative and not restrictive, and the disclosure is not to be limited to the details given herein.

What is claimed is:

1. An LED (light emitting diode) driving circuit, comprising:
an alternating current and direct current (AC/DC) rectifying circuit configured for converting alternating current into direct current;
an LED module comprising a current detecting terminal;
a voltage dropping circuit connected to the LED module for powering the LED module;
a voltage detecting circuit connected between the voltage dropping circuit and the LED module, the voltage detecting circuit comprising a voltage detecting terminal; and
an integrated circuit comprising:
a pulse-width modulation (PWM) control module configured for providing PWM waves;
an overcurrent protection (OCP) module configured for detecting a work current of the LED module via connecting the current detecting terminal;
an overvoltage protection (OVP) module configured for detecting a work voltage via connecting the voltage detecting terminal;
a frequency control module configured for adjusting the duty ratio of the PWM waves provided by the PWM control module according to the work current detected by the OCP module and the work voltage detected by the OVP module to adjust the work current of the LED module.

2. The LED driving circuit as recited in claim 1, wherein the integrated circuit further comprises a voltage adjusting module connected to the AC/DC rectifying circuit, and the voltage adjusting module is configured for converting a high voltage from the AC/DC rectifying circuit into a low voltage for powering the integrated circuit.

3. The LED driving circuit as recited in claim 1, wherein the voltage dropping circuit comprises an inductance, for converting a high voltage converted by the AC/DC rectifying circuit into the low voltage.

4. The LED driving circuit as recited in claim 1, wherein the LED module comprises a plurality of LEDs connected in series, the plurality of LEDs are grounded via a resistor, and the current detecting terminal is arranged between the resistor and an adjacent one of the LEDs.

5. The LED driving circuit as recited in claim 1, wherein the voltage detecting circuit comprises a first dividing resistor and a second dividing resistor connected in series, and the voltage detecting terminal is arranged between the first dividing resistor and the second dividing resistor.

6. The LED driving circuit as recited in claim 5, wherein when the LED module is in work, the OCP module compares a value of the work current detected by the current detecting terminal with a reference current of the LED module, the OVP module compares a value of the work voltage detected by the voltage detecting terminal with a reference voltage of the LED module, the frequency control module controls a duty ratio of the PWM waves provided by the PWM control module according to the comparing results provided by the OCP module and the OVP module.

7. The LED driving circuit as recited in claim 1, further comprising a shunt circuit connected to the PWM control module, wherein the shunt circuit is controlled to be connected to or disconnected from the voltage dropping circuit periodically by the PWM waves provided by the PWM control module, thereby controlling the current provided by the voltage dropping circuit to flow to the LED module or flow to the shunt circuit periodically to adjust the operating current of the LED module.

8. The LED driving circuit as recited in claim 7, wherein the shunt circuit comprises a switch connected to the PWM control module and controlled by the PWM waves provided by the PWM control module.

9. The LED driving circuit as recited in claim 8, wherein when the PWM control module outputs a low level to cause the switch to be turned off, the shunt circuit is disconnected from the voltage dropping circuit, and the current converted by the voltage dropping circuit flows to the LED module; when the PWM control module outputs a high level to cause the switch to be turned on, the shunt circuit is connected to the voltage dropping circuit, and the current converted by the voltage dropping circuit flows to the shunt circuit.
